(19) United States
(12) Patent Application Publication
(10) Pub. No.: US 2020/0239743 A1
(43) Pub. Date: Jul. 30, 2020

(54) OPTICAL ADHESIVE LAYER, MANUFACTURING METHOD OF OPTICAL ADHESIVE LAYER, OPTICAL FILM WITH ADHESIVE LAYER, AND IMAGE DISPLAY DEVICE

(71) Applicant: NITTO DENKO CORPORATION, Osaka (JP)

(72) Inventors: Tomoyuki Kimura, Ibaraki-shi (JP); Hirotomo Ono, Ibaraki-shi (JP); Akiko Sugino, Ibaraki-shi (JP); Yusuke Toyama, Ibaraki-shi (JP)

(73) Assignee: NITTO DENKO CORPORATION, Osaka (JP)

(21) Appl. No.: 16/846,698

(22) Filed: Apr. 13, 2020

Related U.S. Application Data
(62) Division of application No. 16/337,056, filed on Mar. 27, 2019.

(30) Foreign Application Priority Data
Sep. 30, 2016 (JP) 2016-194539

(51) Int. Cl. C09J 7/38; G02F 1/1333; C09J 133/14; C08K 5/14; C08F 220/30; C08F 220/28; C09J 7/25

(52) U.S. Cl. CPC C09J 7/385; G02F 1/1333; C09J 133/14; C08K 5/14; C09J 2201/622; C08F 220/28; C09J 7/25; C08F 220/302; C08F 220/283; C08F 220/30

(57) ABSTRACT

An optical pressure-sensitive adhesive layer which can suppress the occurrence of foaming, peeling, lifting etc. on an adherend (an optical film) even when exposed to heating and humidification conditions; has excellent durability; can suppress surface unevenness due to light leakage; can suppress increases in adhering strength; and has excellent reworkability. An optical pressure-sensitive adhesive layer formed from a pressure-sensitive adhesive composition containing a (meth)acrylic polymer that contains 3 to 25% by weight of an aromatic ring-containing monomer as a monomer unit and has a polydispersity (weight average molecular weight (Mw)/number average molecular weight (Mn)) of 3.0 or less, wherein the optical pressure-sensitive adhesive layer has an adhering strength of 11 N/25 mm or less to glass.

### CROSS-REFERENCE TO RELATED APPLICATIONS

This application is a divisional of U.S. application Ser. No. 16/337,056, filed on Mar. 27, 2019, which is a 371 of International Application No. PCT/JP2017/034993, filed on Sep. 27, 2017, which is based upon and claims the benefit of priority from the prior Japanese Patent Application No. 2016-194539, filed on Sep. 30, 2016, the entire contents of which are incorporated herein by reference.

### TECHNICAL FIELD

The present invention relates to an optical pressure-sensitive adhesive layer, a method for producing an optical pressure-sensitive adhesive layer, and a pressure-sensitive adhesive layer attached optical film having the optical pressure-sensitive adhesive layer on at least one side of an optical film. Furthermore, the present invention relates to an image display device using the pressure-sensitive adhesive layer attached optical film, such as a liquid crystal display device, an organic EL display device, and a PDP. As the optical film, a polarizing film (a polarizing plate), a retardation film, an optical compensation film, a brightness enhancement film, and a laminate thereof can be used.

### BACKGROUND ART

In a liquid crystal display device or the like, it is indispensable to dispose polarizing elements on both sides of a liquid crystal cell from the image forming method, and generally polarizing films are bonded thereto. In addition to polarizing films, various optical elements for improving the display quality of displays have come into use in liquid crystal panels. For example, retardation films for preventing discoloration, viewing angle expansion films for improving the viewing angle of liquid crystal displays, and brightness enhancement films for improving the contrast of displays are used. These films are collectively called optical films.

In general, a pressure-sensitive adhesive is used to bond an optical member such as the optical film to a liquid crystal cell. In order to reduce optical losses, the optical film and the liquid crystal cell or the optical films are generally bonded together with a pressure-sensitive adhesive. In such a case, the pressure-sensitive adhesive is provided in advance as a pressure-sensitive adhesive layer on one side of the optical film, and the resulting pressure-sensitive adhesive layer attached optical film is generally used because it has some advantages such as no need for a drying process to fix the optical film. In general, a release film is attached to the pressure-sensitive adhesive layer of the pressure-sensitive adhesive layer attached optical film.

The required properties required for the pressure-sensitive adhesive layer include high durability under heating/humidification conditions in a state in which the pressure-sensitive adhesive layer is stuck to an optical film and in a state in which the pressure-sensitive adhesive layer attached optical film is bonded to a glass substrate of a liquid crystal panel. For example, in a durability test under heating and humidification conditions etc. commonly conducted as an environment promotion test, high adhesion reliability and the like that no defects such as foaming, peeling, lifting, etc. caused by the pressure-sensitive adhesive layer occur are required.

In particular, pressure-sensitive adhesive layers or a pressure-sensitive adhesive layer attached optical films used for outdoor use of cellular phones or used for in-vehicle displays such as a car navigation system where a high-temperature interior of a car is supposed are required to have high adhesion reliability and durability at high temperature.

In addition, in recent years, displays with curved designs are increasing. In this case, it is necessary to reduce the thickness of a glass substrate in order to bend a liquid crystal panel, and such a panel is easily broken during the rework operation of a polarizing plate, so adhering strength of a pressure-sensitive adhesive is suppressed and an improved reworkability is required. Particularly in a curved display for in-vehicle use, it is necessary to also satisfy adhesion reliability at high temperature and realize compatibility of conflicting characteristics at a high level.

Further, an optical film (for example, a polarizing plate) tends to shrink by heat treatment. The shrinkage of the polarizing plate causes a base polymer forming a pressure-sensitive adhesive layer to be aligned, so that a phase difference is generated, which is a problem of display unevenness due to light leakage. Therefore, it is required to suppress display unevenness in the pressure-sensitive adhesive layer.

Various pressure-sensitive adhesive compositions for forming a pressure-sensitive adhesive layer of the pressure-sensitive adhesive layer attached optical film have been proposed (for example, Patent Documents 1 to 3).

### PRIOR ART DOCUMENT

### Patent Document

Patent Document 1: JP-A-2012-158702
Patent Document 2: JP-A-2009-215528
Patent Document 3: JP-A-2009-242767

### SUMMARY OF THE INVENTION

### Problems to be Solved by the Invention

Patent Document 1 proposes a pressure-sensitive adhesive composition in which 4 to 20 parts by weight of an isocyanate-based crosslinking agent is blended with 100 parts by weight of an acrylic polymer containing a polar monomer such as an aromatic ring-containing monomer and an amide group-containing monomer. However, since the pressure-sensitive adhesive composition of Patent Document 1 contains a large proportion of the crosslinking agent, peeling tends to easily occur in a durability test.

Patent Documents 2 and 3 propose a pressure-sensitive adhesive composition comprising a (meth)acrylic polymer including an aromatic ring-containing (meth)acrylate and an amino group-containing (meth)acrylate, and a crosslinking agent. However, the pressure-sensitive adhesive layer made from the pressure-sensitive adhesive composition according to Patent Documents 2 and 3 has poor adhesiveness to a transparent conductive layer (ITO layer) and cannot satisfy particularly durability in a high temperature test assuming for in-vehicle use. In Patent Document 2, the Comparative Examples show the use of an amide group-containing monomer instead of the amino group-containing (meth)acrylate. However, the results in Table 2 of each of Patent Documents 2 and 3 show that a satisfactory level of durability is not achieved when the amide group-containing monomer is used.

In addition, when an aromatic ring-containing monomer is used, the glass transition temperature (Tg) of the resulting (meth)acrylic polymer tends to increase, so that the adhering strength of the obtained pressure-sensitive adhesive layer increases to cause the problem of poor reworkability.

Therefore, the purpose of the present invention is to provide an optical pressure-sensitive adhesive layer which can suppress the occurrence of foaming, peeling, lifting, etc. on an adherend (an optical film) even when exposed to severe heating and humidification conditions assuming in-vehicle use; has excellent durability; can suppress display unevenness due to light leakage; can suppress increases in adhering strength; and has excellent reworkability.

Another object of the present invention is to provide a method for manufacturing the optical pressure-sensitive adhesive layer and a pressure-sensitive adhesive layer attached optical film having the optical pressure-sensitive adhesive layer, and further to provide an image display device using the pressure-sensitive adhesive layer attached optical film.

### Means for Solving the Problems

As a result of intensive studies to solve the above problems, the present inventors have found the following optical pressure-sensitive adhesive layer and have completed the present invention.

That is, the optical pressure-sensitive adhesive layer of the present invention is characterized by being an optical pressure-sensitive adhesive layer formed from a pressure-sensitive adhesive composition comprising a (meth)acrylic polymer that contains 3 to 25% by weight of an aromatic ring-containing monomer as a monomer unit and has a polydispersity (weight average molecular weight (Mw)/number average molecular weight (Mn)) of 3.0 or less, the optical pressure-sensitive adhesive layer has an adhering strength of 11 N/25 mm or less to glass.

In the optical pressure-sensitive adhesive layer of the present invention, it is preferable that a glass transition temperature (Tg) of the aromatic ring-containing monomer is 0° C. or less.

In the optical pressure-sensitive adhesive layer of the present invention, it is preferable that the aromatic ring-containing monomer is phenoxyethyl (meth)acrylate.

In the optical pressure-sensitive adhesive layer of the present invention, a weight average molecular weight (Mw) of the (meth)acrylic polymer is preferably 900,000 to 3,000,000.

In the optical pressure-sensitive adhesive layer of the present invention, it is preferable that the (meth)acrylic polymer contains 1.5% by weight or less of a carboxyl group-containing monomer as a monomer unit.

In the optical pressure-sensitive adhesive layer of the present invention, it is preferable that the (meth)acrylic polymer contains 0.1 to 15% by weight of an N-vinyl group-containing lactam-based monomer as a monomer unit.

In the optical pressure-sensitive adhesive layer of the present invention, it is preferable that a peroxide-based crosslinking agent is contained in an amount of 0.01 to 3 parts by weight based on 100 parts by weight of the (meth)acrylic polymer.

In the optical pressure-sensitive adhesive layer of the present invention, it is preferable that the pressure-sensitive adhesive composition contains an organic tellurium compound.

The method for manufacturing an optical pressure-sensitive adhesive layer of the present invention is the above-mentioned method for manufacturing a pressure-sensitive adhesive layer for optical use, and it is preferable to manufacture the (meth)acrylic polymer by living radical polymerization.

The pressure-sensitive adhesive layer attached optical film of the present invention preferably comprising the optical pressure-sensitive adhesive layer on at least one side of the optical film.

In the image display device of the present invention, it is preferable that at least one pressure-sensitive adhesive layer attached optical film is used.

The optical pressure-sensitive adhesive layer of the present invention is characterized by being an optical pressure-sensitive adhesive layer formed from a pressure-sensitive adhesive composition containing a (meth)acrylic polymer that contains 3 to 25% by weight of an aromatic ring-containing monomer as a monomer unit and has a polydispersity (weight average molecular weight (Mw)/number average molecular weight (Mn)) of 3.0 or less, the adhesive layer has an adhering strength of 11 N/25 mm or less to glass. Even when the optical pressure-sensitive adhesive layer is exposed to heating and humidification conditions in a state of being adhered to an optical film, the optical pressure-sensitive adhesive layer can suppress the occurrence of foaming, peeling, lifting, etc.; has high adhesion reliability and excellent durability even in a high humidity environment; can suppress display unevenness due to light leakage; can suppress increases in adhering strength; and has excellent reworkability. Thus, the optical pressure-sensitive adhesive layer of the present invention is useful.

Further, when an image display device such as a liquid crystal display device using a pressure-sensitive adhesive layer attached optical film such as a pressure-sensitive adhesive layer attached a polarizing plate is exposed to heating and humidification conditions, display unevenness occurs due to peripheral irregularities or corner irregularities (white voids) in the peripheral portion of the liquid crystal panel and the like and defective display may occur. However, the optical pressure-sensitive adhesive layer of the present invention can suppress display unevenness due to light leakage in the peripheral portion of the display screen.

### BRIEF DESCRIPTION OF THE DRAWINGS

FIG. 1 is an example of a schematic cross-sectional view of a pressure-sensitive adhesive layer attached a polarizing film according to the present invention.

### MODE FOR CARRYING OUT THE INVENTION

### <(Meth)Acrylic Polymer>

The optical pressure-sensitive adhesive layer of the present invention is characterized by being formed from a pressure-sensitive adhesive composition containing a (meth)acrylic polymer. The (meth)acrylic polymer usually contains an alkyl (meth)acrylate monomer unit as a main component. Incidentally, the term “(meth)acrylate” refers to acrylate and/or methacrylate, and the term “(meth)” is used in the same meaning in the present invention.

As the alkyl (meth)acrylate forming the main skeleton of the (meth)acrylic polymer, a linear or branched alkyl group having 1 to 18 carbon atoms can be exemplified. Examples of such alkyl group include methyl, ethyl, propyl, isopropyl, butyl, isobutyl, amyl, hexyl, cyclohexyl, heptyl, 2-ethylhexyl, isooctyl, nonyl, decyl, isodecyl, dodecyl, isomyristyl, lauryl, tridecyl, pentadecyl, hexadecyl, heptadecyl, and octadecyl groups, and the like. These can be used alone or in combination. The average number of carbon atoms of these alkyl groups is preferably from 3 to 9.

It is preferable that the (meth)acrylic polymer does not contain a carboxyl group-containing monomer as a monomer unit. When the carboxyl group-containing monomer is contained in the (meth)acrylic polymer, durability (for example, metal corrosion resistance) may not be satisfied in some cases, which is also undesirable from the viewpoint of reworkability. When the carboxyl group-containing monomer is used, it is preferable that the carboxyl group-containing monomer is a compound containing a carboxyl group in its structure and containing a polymerizable unsaturated double bond such as a (meth)acryloyl group and a vinyl group. Specific examples of the carboxyl group-containing monomer include (meth)acrylic acid, carboxyethyl (meth)acrylate, carboxypentyl (meth)acrylate, itaconic acid, maleic acid, fumaric acid, crotonic acid, and the like. Among the carboxyl group-containing monomers, acrylic acid is preferable from the viewpoints of copolymerizability, cost, and adhesive properties. In addition, if a small amount of the carboxyl group-containing monomer is used, it is possible to suppress an increase in adhering strength over time, and to improve durability and reworkability.

It is preferable that the (meth)acrylic polymer contains a hydroxyl group-containing monomer as a monomer unit. The hydroxyl group-containing monomer is preferably a compound containing a hydroxyl group in its structure and containing a polymerizable unsaturated double bond such as a (meth)acryloyl group or a vinyl group. Specific examples of the hydroxyl group-containing monomer include hydroxyalkyl (meth)acrylates such as 2-hydroxyethyl (meth)acrylate, 3-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, and 12-hydroxylauryl (meth)acrylate, and (4-hydroxymethylcyclohexyl)-methylacrylate. Among the hydroxyl group-containing monomers, from the viewpoint of durability, 2-hydroxyethyl (meth)acrylate and 4-hydroxybutyl (meth)acrylate are preferable, and 4-hydroxybutyl (meth)acrylate is particularly preferable.

The (meth)acrylic polymer is characterized by containing an aromatic ring-containing monomer as a monomer unit. The aromatic ring-containing monomer is preferably a compound containing an aromatic ring structure in its structure and containing a (meth)acryloyl group (hereinafter sometimes referred to as an aromatic ring-containing (meth)acrylate). Examples of the aromatic ring include a benzene ring, a naphthalene ring, and a biphenyl ring. In particular, the aromatic ring-containing monomer can satisfy the durability (in particular, the durability against an ITO layer which is a transparent conductive layer) and can improve display unevenness due to white voids in the peripheral portion.

Incidentally, the glass transition temperature (Tg) of a (meth)acrylic polymer copolymerized with an aromatic ring-containing monomer tends to rise, and along with this, there is a fear of an increase in the adhering strength, which may result in inferior reworkability. Therefore, the glass transition temperature (Tg) of the aromatic ring-containing monomer is preferably 0° C. or less, more preferably −10° C. or less, even more preferably −20° C. or less. Further, the glass transition temperature (Tg) of the aromatic ring-containing monomer is preferably −100° C. or more.

Specific examples of the aromatic ring-containing monomer include styrene, p-tert-butoxystyrene, and p-acetoxystyrene.

Specific examples of the aromatic ring-containing (meth)acrylate include benzene ring-containing (meth)acrylates such as benzyl (meth)acrylate, phenyl (meth)acrylate, o-phenylphenol (meth)acrylate, phenoxy (meth)acrylate, phenoxyethyl (meth)acrylate, phenoxypropyl (meth)acrylate, phenoxydiethylene glycol (meth)acrylate, ethylene oxide modified nonylphenol (meth)acrylate, ethylene oxide modified cresol (meth)acrylate, phenol ethylene oxide modified (meth)acrylate, 2-hydroxy-3-phenoxypropyl (meth)acrylate, methoxybenzyl (meth)acrylate, chlorobenzyl (meth)acrylate, cresyl (meth)acrylate, and polystyryl (meth)acrylate; naphthalene ring-containing (meth)acrylates such as hydroxyethylated β-naphthol acrylate, 2-naphthoethyl (meth)acrylate, 2-naphthoxyethyl acrylate, and 2-(4-methoxy-1-naphthoxy)ethyl (meth)acrylate; and biphenyl ring-containing (meth)acrylates such as biphenyl (meth)acrylate.

Benzyl (meth)acrylate and phenoxyethyl (meth)acrylate are preferable as the aromatic ring-containing (meth)acrylate from the viewpoints of adhesive properties and durability, and phenoxyethyl (meth)acrylate having a low glass transition temperature (Tg: −22° C.) is particularly preferable.

It is preferable that the (meth)acrylic polymer contains an amide group-containing monomer as a monomer unit. The amide group-containing monomer is preferably a compound having an amide group in its structure and also having a polymerizable unsaturated double bond such as a (meth)acryloyl group and a vinyl group. Specific examples of the amide group-containing monomer include acrylamide monomers such as (meth)acrylamide, N,N-dimethyl (meth)acrylamide, N,N-diethyl (meth)acrylamide, N-isopropyl acrylamide, N-methyl (meth)acrylamide, N-butyl (meth)acrylamide, N-hexyl (meth)acrylamide, N-methylol (meth)acrylamide, N-methylol-N-propane (meth)acrylamide, aminomethyl (meth)acrylamide, aminoethyl (meth)acrylamide, mercaptomethyl (meth)acrylamide, and mercaptoethyl (meth)acrylamide; N-acryloyl heterocyclic monomers such as N-(meth)acryloylmorpholine, N-(meth)acryloylpiperidine, and N-(meth)acryloylpyrrolidine; and N-vinyl group-containing lactam-based monomers such as N-vinylpyrrolidone and N-vinyl-c-caprolactam. The amide group-containing monomers are preferred in terms of satisfying durability and among the amide group-containing monomers, N-vinyl group-containing lactam-based monomers are particularly preferable from the viewpoint of satisfying durability against an ITO layer and reworkability.

These copolymerizable monomers serve as reactive points with a crosslinking agent when a pressure-sensitive adhesive composition contains a crosslinking agent. In particular, since a hydroxyl group-containing monomer is rich in reactivity with an intermolecular crosslinking agent, such a monomer is preferably used from the viewpoint of improving cohesiveness and heat resistance of the obtained pressure-sensitive adhesive layer, and furthermore, from the viewpoint of reworkability.

The (meth)acrylic polymer contains a predetermined amount of each monomer as a monomer unit in a weight ratio of all constituent monomers (100% by weight). The weight ratio of alkyl (meth)acrylate can be set as the balance of monomers other than alkyl (meth) acrylate, specifically, the weight ratio of alkyl (meth)acrylate is preferably 60% by weight or more, more preferably from 65 to 99.8% by weight, even more preferably from 70 to 99.6% by weight. It is preferable to set the weight ratio of alkyl (meth)acrylate within the above range in order to ensure adhesion property.

The weight ratio of the carboxyl group-containing monomer is preferably 1.5% by weight or less, more preferably 0.5% by weight or less, and even more preferably, the carboxyl group-containing monomer is not contained. When the weight ratio of the carboxyl group-containing monomer exceeds 1.5% by weight, there is a tendency such that the pressure-sensitive adhesive (layer) tends to be hard in a high temperature test, and durability may not be satisfied.

The weight ratio of the hydroxyl group-containing monomer is preferably from 0.01 to 7% by weight, more preferably from 0.1 to 6% by weight, even more preferably from 0.3 to 5% by weight. When the weight ratio of the hydroxyl group-containing monomer is less than 0.01% by weight, the pressure-sensitive adhesive layer becomes insufficient in crosslinking and may not be able to satisfy durability and adhesive properties, whereas when such weight ratio exceeds 10% by weight, durability may not be satisfied.

The weight ratio of the aromatic ring-containing monomer is from 3 to 25% by weight, preferably from 8 to 24% by weight, more preferably from 10 to 22% by weight, even more preferably from 12 to 18% by weight. When the weight ratio of the aromatic ring-containing monomer is less than 3% by weight, the display unevenness due to light leakage cannot be sufficiently suppressed. On the other hand, when the weight ratio of the aromatic ring-containing monomer exceeds 25% by weight, the display unevenness is not sufficiently suppressed, and the durability is also lowered.

The weight ratio of the amide group-containing monomer is preferably from 0.1 to 15% by weight, more preferably from 0.3 to 10% by weight, even more preferably from 0.3 to 8% by weight, particularly preferably from 0.7 to 6% by weight. When the weight ratio of the amide group-containing monomer (in particular, an N-vinyl group-containing lactam-based monomer) is within the above range, durability can be satisfied particularly against an ITO layer. If the weight ratio of the amide group-containing monomer exceeds 15% by weight, such a weight ratio is not preferable from the viewpoint of reworkability.

The (meth)acrylic polymer does not need to contain any other monomer unit than the monomer units described above. In order to improve adhesion property and heat resistance, however, one or more copolymerizable monomers having an unsaturated double bond-containing polymerizable functional group, such as a (meth)acryloyl group or a vinyl group, may be introduced into the polymer by copolymerization.

Specific examples of such copolymerizable monomers include acid anhydride group-containing monomers such as maleic anhydride and itaconic anhydride; caprolactone adducts of acrylic acid; sulfonic acid group-containing monomers such as allylsulfonic acid, 2-(meth)acrylamido-2-methylpropane sulfonic acid, (meth)acrylamidopropane sulfonic acid, and sulfopropyl (meth)acrylate; and phosphate group-containing monomers such as 2-hydroxyethylacryloyl phosphate.

Examples of such monomers for modification also include alkylaminoalkyl (meth)acrylates such as aminoethyl (meth)acrylate, N,N-dimethylaminoethyl (meth)acrylate, and tert-butylaminoethyl (meth)acrylate; alkoxyalkyl (meth)acrylates such as methoxyethyl (meth)acrylate and ethoxyethyl (meth)acrylate; succinimide monomers such as N-(meth)acryloyloxymethylenesuccinimide, N-(meth)acryloyl-6-oxyhexamethylenesuccinimide, and N-(meth)acryloyl-8-oxyoctamethylenesuccinimide; maleimide monomers such as N-cyclohexylmaleimide, N-isopropylmaleimide, N-laurylmaleimide, and N-phenylmaleimide; and itaconimide monomers such as N-methylitaconimide, N-ethylitaconimide, N-butylitaconimide, N-octylitaconimide, N-2-ethylhexylitaconimide, N-cyclohexylitaconimide, and N-laurylitaconimide.

Examples of modifying monomers that may also be used include vinyl monomers such as vinyl acetate and vinyl propionate; cyanoacrylate monomers such as acrylonitrile and methacrylonitrile; epoxy group-containing (meth)acrylates such as glycidyl (meth)acrylate; glycol (meth)acrylates such as polyethylene glycol (meth)acrylate, polypropylene glycol (meth)acrylate, methoxyethylene glycol (meth)acrylate, and methoxypolypropylene glycol (meth)acrylate; and (meth)acrylate monomers such as tetrahydrofurfuryl (meth)acrylate, fluoro (meth)acrylate, silicone (meth)acrylate, and 2-methoxyethyl acrylate. Further, isoprene, butadiene, isobutylene, vinyl ether and the like can be exemplified.

Besides the above, a silicon atom-containing silane monomer may be exemplified as the copolymerizable monomer. Examples of the silane monomers include 3-acryloxypropyltriethoxysilane, vinyltrimethoxysilane, vinyltriethoxysilane, 4-vinylbutyltrimethoxysilane, 4-vinylbutyltriethoxysilane, 8-vinyloctyltrimethoxysilane, 8-vinyloctyltriethoxysilane, 10-methacryloyloxydecyltrimethoxysilane, 10-acryloyloxydecyltrimethoxysilane, 10-methacryloyloxydecyltriethoxysilane, and 10-acryloyloxydecyltriethoxysilane.

Copolymerizable monomers that may be used also include polyfunctional monomers having two or more unsaturated double bonds such as (meth)acryloyl groups or vinyl groups, which include (meth)acrylate esters of polyhydric alcohols, such as tripropylene glycol di(meth)acrylate, tetraethylene glycol di(meth)acrylate, 1,6-hexanediol di(meth)acrylate, bisphenol A diglycidyl ether di(meth)acrylate, neopentyl glycol di(meth)acrylate, trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate, and caprolactone-modified dipentaerythritol hexa(meth)acrylate; and compounds having a polyester, epoxy or urethane skeleton to which two or more unsaturated double bonds are added in the form of functional groups such as (meth)acryloyl groups or vinyl groups in the same manner as the monomer component, such as polyester (meth)acrylates, epoxy (meth)acrylates and urethane (meth)acrylates.

The proportion of the copolymerizable monomer in the (meth)acrylic polymer is preferably about 0 to 10%, more preferably about 0 to 7%, even more preferably about 0 to 5% on the weight ratio basis with respect to all the constituent monomers (100% by weight) of the (meth)acrylic polymer.

The weight average molecular weight (Mw) of the (meth)acrylic polymer is preferably 900,000 to 3,000,000. In consideration of durability, particularly heat resistance, such weight average molecular weight is more preferably from 1,200,000 to 2,500,000. When the weight average molecular weight of the (meth)acrylic polymer is less than 900,000, the low molecular weight polymer component increases and the crosslinking density of the gel (pressure sensitive adhesive layer) increases, with the result that the pressure sensitive adhesive layer becomes hard and the stress relaxation property is impaired, which is not preferable. On the other hand, when the weight average molecular weight is larger than 3,000,000, viscosity of the polymer increases and gelation occurs during polymerization of the polymer, which is not preferable.

The polydispersity (weight average molecular weight (Mw)/number average molecular weight (Mn)) of the (meth)acrylic polymer is 3.0 or less, preferably from 1.05 to 2.5, more preferably from 1.05 to 2.0. When the polydispersity (Mw/Mn) exceeds 3.0, the number of low molecular weight polymers increases, and it is necessary to use a large amount of a crosslinking agent in order to increase a gel fraction of a pressure-sensitive adhesive layer. Thereby, an excessive crosslinking agent reacts with an already gelled polymer to increase the crosslinking density of the gel (pressure-sensitive adhesive layer), and accompanying this, the pressure-sensitive adhesive layer becomes hard and the stress relaxation property is impaired, which is not preferable. In addition, when there are many low molecular weight polymers and uncrosslinked polymers or oligomers (sol contents) are increased, it is presumed that a fragile layer is formed in the pressure-sensitive adhesive layer by uncrosslinked polymers segregated in the vicinity of the interface of the pressure-sensitive adhesive layer in contact with an adherend (for example, ITO or the like). However, it is presumed that when the pressure-sensitive adhesive layer is exposed to a heating/humidification environment, destruction of the pressure-sensitive adhesive layer occurs in the vicinity of the fragile layer, causing peeling of the pressure-sensitive adhesive layer, so that the polydispersity (Mw/Mn) is adjusted to 3.0 or less. Further, by adjusting such a polydispersity, even if an aromatic ring-containing monomer or the like having a high glass transition temperature (Tg) is used as the monomer constituting the (meth)acrylic polymer, it is possible to suppress an increase in the adhering strength of the pressure-sensitive adhesive layer, so that compatibility between reworkability and suppression of display unevenness due to light leakage can be achieved, which is a preferable embodiment. The weight average molecular weight and the polydispersity (Mw/Mn) are determined by GPC (gel permeation chromatography) and calculated from polystyrene conversion.

For the production of such a (meth)acrylic polymer, any appropriate method may be selected from known production methods such as solution polymerization, bulk polymerization, emulsion polymerization, and various radical polymerization. Among them, from the viewpoints of convenience and versatility, the solution polymerization is preferable. A living radical polymerization is also preferable from the viewpoint that production of low molecular weight oligomers can be suppressed, and productivity can be ensured even when the polymerization rate is increased. In addition, the obtained (meth)acrylic polymer may be any type of a random copolymer, a block copolymer, a graft copolymer and the like.

In the solution polymerization, for example, ethyl acetate, toluene or the like is used as a polymerization solvent. In a specific solution polymerization, for example, the reaction is performed under a stream of inert gas such as nitrogen at a temperature of about 50 to 70° C. for about 10 minutes to 30 hours in the presence of a polymerization initiator. In particular, by shortening the polymerization time to about 30 minutes to 3 hours, adhesion reliability of the pressure-sensitive adhesive can be improved by suppressing the formation of low molecular weight oligomers generated in the later stage of polymerization.

The polymerization initiators, chain transfer agents, emulsifiers and the like used for the radical polymerization are not particularly limited and can be appropriately selected and used. The weight average molecular weight of the (meth)acrylic polymer can be controlled by the amount of the polymerization initiator and the chain transfer agent used, and the reaction conditions, and the amount used thereof is appropriately adjusted according to these types.

### <Polymerization Initiator>

Examples of the polymerization initiator include, but are not limited to, azo-based initiators such as 2,2′-azobisisobutylonitrile, 2,2′-azobis(2-amidinopropane) dihydrochloride, 2,2′-azobis[2-(5-methyl-2-imidazolin-2-yl)propane]dihydrochloride, 2,2′-azobis(2-methylpropionamidine) disulfate, 2,2′-azobis(N,N′-dimethyleneisobutylamidine), and 2,2′-azobis[N-(2-carboxyethyl)-2-methylpropionamidine]hydrate (VA-057, manufactured by Wako Pure Chemical Industries, Ltd.); persulfates such as potassium persulfate and ammonium persulfate; peroxide-based initiators such as di(2-ethylhexyl)peroxydicarbonate, di(4-tert-butylcyclohexyl)peroxydicarbonate, di-sec-butylperoxydicarbonate, tert-butylperoxyneodecanoate, tert-hexylperoxypivalate, tert-butylperoxypivalate, dilauroyl peroxide, di-n-octanoyl peroxide, 1,1,3,3-tetramethylbutylperoxy-2-ethyl hexanoate, di(4-methylbenzoyl) peroxide, dibenzoyl peroxide, tert-butylperoxyisobutylate, 1,1-di(tert-hexylperoxy)cyclohexane, tert-butylhydroperoxide, and hydrogen peroxide; and redox system initiators of a combination of a peroxide and a reducing agent, such as a combination of a persulfate and sodium hydrogen sulfite and a combination of a peroxide and sodium ascorbate. Also, as a polymerization initiator used for living radical polymerization, there are exemplified organic tellurium compounds including, for example, (methyltellanyl-methyl)benzene, (1-methyltellanyl-ethyl)benzene, (2-methyltellanyl-propyl)benzene, 1-chloro-4-(methyltellanyl-methyl)benzene, 1-hydroxy-4-(methyltellanyl-methyl)benzene, 1-methoxy-4-(methyltellanyl-methyl)benzene, 1-amino-4-(methyltellanyl-methyl)benzene, 1-nitro-4-(methyltellanyl-methyl)benzene, 1-cyano-4-(methyltellanyl-methyl)benzene, 1-methylcarbonyl-4-(methyltellanyl-methyl)benzene, 1-phenylcarbonyl-4-(methyltellanyl-methyl)benzene, 1-methoxycarbonyl-4-(methyltellanyl-methyl)benzene, 1-phenoxycarbonyl-4-(methyltellanyl-methyl)benzene, 1-sulfonyl-4-(methyltellanyl-methyl)benzene, 1-trifluoromethyl-4-(methyltellanyl-methyl)benzene, 1-chloro-4-(1-methyltellanyl-ethyl)benzene, 1-hydroxy-4-(1-methyltellanyl-ethyl)benzene, 1-methoxy-4-(1-methyltellanyl-ethyl)benzene, 1-amino-4-(1-methyltellanyl-ethyl)benzene, 1-nitro-4-(1-methyltellanyl-ethyl)benzene, 1-cyano-4-(l-methyltellanyl-ethyl)benzene, 1-methylcarbonyl-4-(1-methyltellanyl-ethyl)benzene, 1-phenylcarbonyl-4-(1-methyltellanyl-ethyl)benzene, 1-methoxycarbonyl-4-(1-methyltellanyl-ethyl)benzene, 1-phenoxycarbonyl-4-(1-methyltellanyl-ethyl)benzene, 1-sulfonyl-4-(1-methyltellanyl-ethyl)benzene, 1-trifluoromethyl-4-(1-methyltellanyl-ethyl)benzene, 1-chloro-4-(2-methyltellanyl-propyl)benzene, 1-hydroxy-4-(2-methyltellanyl-propyl)benzene, 1-methoxy-4-(2-methyltellanyl-propyl)benzene, 1-amino-4-(2-methyltellanyl-propyl)benzene, 1-nitro-4-(2-methyltellanyl-propyl)benzene, 1-cyano-4-(2-methyltellanyl-propyl)benzene, 1-methylcarbonyl-4-(2-methyltellanyl-propyl)benzene, 1-phenylcarbonyl-4-(2-methyltellanyl-propyl)benzene, 1-methoxycarbonyl-4-(2-methyltellanyl-propyl)benzene, 1-phenoxycarbonyl-4-(2-methyltellanyl-propyl)benzene, 1-sulfonyl-4-(2-methyltellanyl-propyl)benzene, 1-trifluoromethyl-4-(2-methyltellanyl-propyl)benzene, 2-(methyltellanyl-methyl)pyridine, 2-(1-methyltellanyl-ethyl)pyridine, 2-(2-methyltellanyl-propyl)pyridine, methyl 2-methyltellanyl-ethanoate, methyl 2-methyltellanyl-propionate, methyl 2-methyltellanyl-2-methylpropionate, ethyl 2-methyltellanyl-ethanoate, ethyl 2-methyltellanyl-propionate, ethyl 2-methyltellanyl-2-methylpropionate, 2-methyltellanyl acetonitrile, 2-methyltellanyl propionitrile, 2-methyl-2-methyltellanyl propionitrile, and the like. The methyltellanyl group in these organotellurium compounds may be substituted with an ethyltellanyl group, an n-propyltellanyl group, an isopropyltellanyl group, an n-butyltellanyl group, an isobutyltellanyl group, a t-butyltellanyl group, a phenyltellanyl group or the like.

The polymerization initiator may be used alone or as a mixture of two or more kinds thereof, but the content as a whole is preferably about 0.005 to 1 part by weight, more preferably about 0.02 to 0.5 parts by weight, per 100 parts by weight of the total amount of the monomer components.

Incidentally, in order to prepare a (meth)acrylic polymer having the weight average molecular weight (Mw) and the polydispersity (Mw/Mn) described above, the polymerization initiator, for example, 2,2′-azobisisobutyronitrile is used in an amount of preferably about 0.06 to 0.2 parts by weight, more preferably about 0.08 to 0.175 parts by weight, per 100 parts by weight of the total amount of the monomer components.

Examples of the chain transfer agent include lauryl mercaptan, glycidyl mercaptan, mercaptoacetic acid, 2-mercaptoethanol, thioglycolic acid, 2-ethylhexyl thioglycolate, 2,3-dimercapto-1-propanol and the like. The chain transfer agent may be used alone or as a mixture of two or more kinds thereof, but the total content is about 0.1 parts by weight or less per 100 parts by weight of the total amount of the monomer components.

Examples of the emulsifier used in emulsion polymerization include anionic emulsifiers such as sodium lauryl sulfate, ammonium lauryl sulfate, sodium dodecylbenzenesulfonate, ammonium polyoxyethylene alkyl ether sulfate, and sodium polyoxyethylene alkyl phenyl ether sulfate; and nonionic emulsifiers such as polyoxyethylene alkyl ether, polyoxyethylene alkyl phenyl ether, polyoxyethylene fatty acid ester, and polyoxyethylene-polyoxypropylene block polymers. These emulsifiers may be used alone or in combination of two or more kinds thereof.

Further, as the emulsifier, a reactive emulsifier in which a radically polymerizable functional group such as a propenyl group, an allyl ether group or the like is introduced can be used, and specific examples thereof include AQUALON HS-10, HS-20, KH-10, BC-05, BC-10, and BC-20 (each manufactured by Dai-ichi Kogyo Seiyaku Co., Ltd.) and ADEKARIA SOAP SE10N (manufactured by Asahi Denka Kogyo K.K.). The reactive emulsifier is preferred, because after polymerization, it can be incorporated into a polymer chain to improve water resistance. Based on 100 parts by weight of the total monomer components, the emulsifier is used in an amount of preferably 0.3 to 5 parts by weight, more preferably 0.5 to 1 part by weight, in view of polymerization stability or mechanical stability.

### <Crosslinking Agent>

The pressure-sensitive adhesive composition preferably contains a crosslinking agent. As the crosslinking agent, an organic crosslinking agent or a polyfunctional metal chelate (metal chelate-based crosslinking agent) can be used. Examples of the organic crosslinking agent include an isocyanate-based crosslinking agent, a peroxide-based crosslinking agent, an epoxy-based crosslinking agent, an imine-based crosslinking agent, a carbodiimide-based crosslinking agent and the like. The polyfunctional metal chelate is one in which a polyvalent metal is covalently or coordinately bonded to an organic compound. Examples of the polyvalent metal atom include Al, Cr, Zr, Co, Cu, Fe, Ni, V, Zn, In, Ca, Mg, Mn, Y, Ce, Sr, Ba, Mo, La, Sn, and Ti. The organic compound has a covalent or coordinate bond-forming atom such as an oxygen atom, and examples of the organic compound include an alkyl ester, an alcohol compound, a carboxylic acid compound, an ether compound, a ketone compound, and the like. In particular, by using a peroxide-based crosslinking agent, it is possible to prepare a high molecular weight (meth)acrylic polymer. As a result, a pressure-sensitive adhesive layer excellent in stress relaxation property can be obtained, and peeling in the durability test can be suppressed, which are preferable. In addition, when a peroxide crosslinking agent and an isocyanate crosslinking agent are used in combination, such a combination is more preferable because excellent stress relaxation property can be obtained and adhesiveness to an optical film can be improved.

The isocyanate-based crosslinking agent may be a compound having at least two isocyanate groups. For example, an aliphatic polyisocyanate, an alicyclic polyisocyanate, or an aromatic polyisocyanate known in the art and commonly used for urethane-forming reaction may be used as the isocyanate-based crosslinking agent.

Examples of the aliphatic polyisocyanate include trimethylene diisocyanate, tetramethylene diisocyanate, hexamethylene diisocyanate, pentamethylene diisocyanate, 1,2-propylene diisocyanate, 1,3-butylene diisocyanate, dodecamethylene diisocyanate, 2,4,4-trimethylhexamethylene diisocyanate, and the like.

Examples of the alicyclic isocyanate include 1,3-cyclopentene diisocyanate, 1,3-cyclohexane diisocyanate, 1,4-cyclohexane diisocyanate, isophorone diisocyanate, hydrogenated diphenylmethane diisocyanate, hydrogenated xylylene diisocyanate, hydrogenated tolylene diisocyanate, hydrogenated tetramethylxylylene diisocyanate, and the like.

Examples of the aromatic diisocyanate include phenylene diisocyanate, 2,4-tolylene diisocyanate, 2,6-tolylene diisocyanate, 2,2′-diphenylmethane diisocyanate, 4,4′-diphenylmethane diisocyanate, 4,4′-toluidine diisocyanate, 4,4′-diphenyl ether diisocyanate, 4,4′-diphenyl diisocyanate, 1,5-naphthalene diisocyanate, xylylene diisocyanate, and the like.

Examples of the isocyanate-based crosslinking agent include multimers (such as dimers, trimers, or pentamers) of these diisocyanates, and urethane-modified products formed by the reaction with a polyalcohol such as trimethylolpropane, urea-modified products, biuret-modified products, allophanate-modified products, isocyanurate-modified products, carbodiimide-modified products, and the like.

Commercially available examples of the isocyanate-based crosslinking agent include “MILLIONATE MT”, “MILLIONATE MTL”, “MILLIONATE MR-200”, “MILLIONATE MR-400”, “CORONATE L”, “CORONATE HL”, and “CORONATE HX” (all trade names, manufactured by NIPPON POLYURETHANE INDUSTRY CO., LTD.), and “TAKENATE D-110N”, “TAKENATE D-120N”, “TAKENATE D-140N”, “TAKENATE D-160N”, “TAKENATE D-165N”, “TAKENATE D-170HN”, “TAKENATE D-178N”, “TAKENATE 500”, and “TAKENATE 600” (all trade names, manufactured by Mitsui Chemicals, Inc.). These compounds may be used alone or in combination of two or more kinds thereof.

As the isocyanate-based crosslinking agent, preferred are an aliphatic polyisocyanate and an aliphatic polyisocyanate-based compound that is a modified product thereof. Aliphatic polyisocyanate-based compounds can form a crosslinked structure more flexible than that obtained with other isocyanate crosslinking agents, can easily relax the stress associated with the expansion/shrinkage of optical films, and are less likely to cause peeling in a durability test. In particular, preferred aliphatic polyisocyanate-based compounds include hexamethylene diisocyanate and derivatives thereof.

Any peroxide-based crosslinking agent (sometimes referred to simply as a peroxide) capable of generating active radical species by heating or photoirradiation and promoting the crosslinking of the base polymer ((meth)acrylic polymer) in the pressure-sensitive adhesive composition may be appropriately used. In view of workability and stability, a peroxide with a one-minute half-life temperature of 80° C. to 160° C. is preferably used, and a peroxide with a one-minute half-life temperature of 90° C. to 140° C. is more preferably used.

Examples of the peroxide that can be used include di(2-ethylhexyl) peroxydicarbonate (one-minute half-life temperature: 90.6° C.), di(4-tert-butylcyclohexyl) peroxydicarbonate (one-minute half-life temperature: 92.1° C.), di-sec-butyl peroxydicarbonate (one-minute half-life temperature: 92.4° C.), tert-butyl peroxyneodecanoate (one-minute half-life temperature: 103.5° C.), tert-hexyl peroxypivalate (one-minute half-life temperature: 109.1° C.), tert-butyl peroxypivalate (one-minute half-life temperature: 110.3° C.), dilauroyl peroxide (one-minute half-life temperature: 116.4° C.), di-n-octanoylperoxide (one-minute half-life temperature: 117.4° C.), 1,1,3,3-tetramethylbutylperoxy-2-ethyl hexanoate (one-minute half-life temperature: 124.3° C.), di(4-methylbenzoyl) peroxide (one-minute half-life temperature: 128.2° C.), dibenzoyl peroxide (one-minute half-life temperature: 130.0° C.), tert-butyl peroxyisobutylate (one-minute half-life temperature: 136.1° C.), and 1,1-di(tert-hexylperoxy)cyclohexane (one-minute half-life temperature: 149.2° C.). In particular, di(4-tert-butylcyclohexyl) peroxydicarbonate (one-minute half-life temperature: 92.1° C.), dilauroyl peroxide (one-minute half-life temperature: 116.4° C.), dibenzoyl peroxide (one-minute half-life temperature: 130.0° C.), or the like is preferably used, because they can provide high crosslinking reaction efficiency.

The half-life of the peroxide is an indicator representing the decomposition rate of the peroxide and refers to the time until the remaining amount of the peroxide is halved. The decomposition temperature for obtaining the half-life in arbitrary time and the half-life time obtained at a certain temperature are shown in catalogs furnished by manufacturers, such as “Organic Peroxide Catalog, 9th Edition, May 2003” furnished by NOF CORPORATION.

The amount of decomposition of the peroxide may be determined by measuring the peroxide residue after the reaction process by, for example, HPLC (high performance liquid chromatography).

More specifically, for example, after the reaction process, about 0.2 g of each pressure-sensitive adhesive composition is taken out, immersed in 10 ml of ethyl acetate, subjected to shaking extraction at 25° C. and 120 rpm for 3 hours in a shaker, and then allowed to stand at room temperature for 3 days. Thereafter, 10 ml of acetonitrile is added, and the mixture is shaken at 25° C. and 120 rpm for 30 minutes. About 10 μl of the liquid extract obtained by filtration through a membrane filter (0.45 μm) is subjected to HPLC by injection and analyzed so that the amount of the peroxide after the reaction process is determined.

The amount of the crosslinking agent to be used is preferably 0.01 to 3 parts by weight, more preferably 0.05 to 2 parts by weight, even more preferably 0.1 to 1 part by weight, per 100 parts by weight of the (meth)acrylic polymer. If the amount of the crosslinking agent is less than 0.01 parts by weight, the pressure-sensitive adhesive layer becomes insufficient in crosslinking and there is a possibility that the durability and the adhesive properties may not be satisfied, whereas if the amount of the crosslinking agent exceeds 3 parts by weight, the pressure-sensitive adhesive layer tends to be too hard and the durability tends to decrease.

One type of the isocyanate-based crosslinking agent may be used alone, or may be used as a mixture of two or more types thereof, but the total content of the isocyanate-based crosslinking agent is preferably in an amount of from 0.01 to 2 parts by weight, more preferably from 0.02 to 1.5 parts by weight, even more preferably 0.03 to 1 part by weight, with respect to 100 parts by weight of the (meth)acrylic polymer. In consideration of cohesive strength, peeling prevention in a durability test, etc., the isocyanate-based crosslinking agent can be appropriately contained.

One type of the peroxides may be used singly or two or more types thereof may be used in combination, but the total content of the peroxide is preferably from 0.01 to 3 parts by weight, more preferably 0.04 to 2 parts by weight, even more preferably 0.05 to 1 part by weight, with respect to 100 parts by weight of the (meth)acrylic polymer. In order to adjust processability, reworkability, crosslinking stability, peelability and the like, the total content of the peroxide is appropriately selected within the above range.

The pressure-sensitive adhesive composition of the present invention may contain a silane coupling agent. By using the silane coupling agent, the durability can be improved. Specific examples of the silane coupling agent include epoxy group-containing silane coupling agents such as 3-glycidoxypropyltrimethoxysilane, 3-glycidoxypropyltriethoxysilane, 3-glycidoxypropylmethyldiethoxysilane, and 2-(3,4-epoxycyclohexyl)ethyltrimethoxysilane; amino group-containing silane coupling agents such as 3-aminopropyltrimethoxysilane, N-(2-aminoethyl)-3-aminopropylmethyldimethoxysilane, 3-triethoxysilyl-N-(1,3-dimethylbutylidene)propylamine, and N-phenyl-y-aminopropyltrimethoxysilane; (meth)acrylic group-containing silane coupling agents such as 3-acryloxypropyltrimethoxysilane and 3-methacryloxypropyltriethoxysilane; and isocyanate group-containing silane coupling agents such as 3-isocyanatepropyltriethoxysilane. Epoxy group-containing silane coupling agents are preferred among the silane coupling agents listed above.

As the silane coupling agent, one having a plurality of alkoxysilyl groups in the molecule can also be used. Specific examples thereof include X-41-1053, X-41-1059A, X-41-1056, X-41-1805, X-41-1818, X-41-1810, andX-40-2651 manufactured by Shin-Etsu Chemical Co., Ltd. These silane coupling agents having a plurality of alkoxysilyl groups in the molecule are preferable in that they are less volatile and effective in improving durability due to their two or more alkoxysilyl groups. In particular, these silane coupling agents can provide suitable durability also when the adherend on the pressure-sensitive adhesive layer attached optical film is a transparent conductive layer (such as an ITO), which is less reactive with the alkoxysilyl group than glass. The silane coupling agent having a plurality of alkoxysilyl groups in the molecule is preferably one having an epoxy group in the molecule, more preferably one having two or more epoxy groups in the molecule. The silane coupling agent having a plurality of alkoxysilyl groups and an epoxy group(s) in the molecule tends to provide good durability also when the adherend is a transparent conductive layer (such as an ITO). Specific examples of the silane coupling agent having a plurality of alkoxysilyl groups and an epoxy group(s) in the molecule include X-41-1053, X-41-1059A, and X-41-1056 manufactured by Shin-Etsu Chemical Co., Ltd, among which X-41-1056 manufactured by Shin-Etsu Chemical Co., Ltd. is particularly preferred, which has a high epoxy group content.

The silane coupling agents may be used alone, or a mixture of two or more thereof. The total amount of the silane coupling agent is preferably from 0.001 to 5 parts by weight, more preferably from 0.01 to 1 part by weight, even more preferably from 0.02 to 1 part by weight, particularly preferably from 0.05 to 0.6 parts by weight, per 100 parts by weight of the (meth)acrylic polymer. If the content of the silane coupling agent is within the above range, durability is improved and a suitable level of adhering strength to glass and transparent conductive layers is maintained.

The pressure-sensitive adhesive composition may also contain any other known additive within a range not impairing the properties. For example, an antistatic agent (an ionic compound such as an ionic liquid and an alkali metal salt), a colorant, a powder such as a pigment, a dye, a surfactant, a plasticizer, a tackifier, a surface lubricant, a leveling agent, a softening agent, an antioxidant, an anti-aging agent, a light stabilizer, an ultraviolet absorbing agent, a polymerization inhibitor, an inorganic or organic filler, a metal powder, or a particle- or foil-shaped material may be added as appropriate depending on the intended use. A redox system including an added reducing agent may also be used in the controllable range. These additives are preferably used in an amount of 5 parts by weight or less, more preferably 3 parts by weight or less, even more preferably 1 part by weight or less, per 100 parts by weight of the (meth)acrylic polymer.

### <Pressure-Sensitive Adhesive Layer>

The pressure-sensitive adhesive composition is used to form a pressure-sensitive adhesive layer. In forming the pressure-sensitive adhesive layer, it is preferable to sufficiently consider the influence of the crosslinking treatment temperature and the crosslinking treatment time as well as to adjust the total amount of the crosslinking agent to be used.

The crosslinking treatment temperature and the crosslinking treatment time can be adjusted depending on the crosslinking agent to be used. The crosslinking treatment temperature is preferably 170° C. or less.

Further, the crosslinking treatment may be carried out at the temperature of the drying step of the pressure-sensitive adhesive layer or may be carried out by providing a separate crosslinking treatment step after the drying step.

Regarding the crosslinking treatment time, such treatment time can be set considering productivity and workability, but the treatment time is usually about 0.2 to 20 minutes, preferably about 0.5 to 10 minutes.

### <Pressure-Sensitive Adhesive Layer Attached Optical Film>

The pressure-sensitive adhesive layer attached optical film of the present invention is preferably a film in which the optical pressure-sensitive adhesive layer is formed on at least one side of an optical film. As an example of the optical film, a polarizing film (polarizing plate), a retardation film, an optical compensation film, a brightness enhancement film, a surface treatment film, a scattering prevention film, a transparent conductive film, and a laminate of these films can be used.

As a method of forming the pressure-sensitive adhesive layer, for example, there are exemplified a method in which the pressure-sensitive adhesive composition is applied to a release-treated separator or the like, the polymerization solvent or the like is dried and removed to form a pressure-sensitive adhesive layer, and then the adhesive layer is transferred to an optical film; and a method in which the pressure-sensitive adhesive composition is applied to an optical film and the polymerization solvent or the like is removed by drying to form a pressure-sensitive adhesive layer on the optical film. In applying the pressure-sensitive adhesive, one or more solvents other than the polymerization solvent may be newly added, as appropriate.

### <Separator>

A silicone release liner is preferably used as the release-treated separator. The pressure-sensitive adhesive composition of the present invention may be applied to such a liner and dried to form a pressure-sensitive adhesive layer. In this process, the pressure-sensitive adhesive may be dried using any appropriate method depending on the purpose. A method of drying by heating the coating film which is the pressure-sensitive adhesive composition is applied is preferably used. The heat drying temperature is preferably from 40° C. to 200° C., more preferably from 50° C. to 180° C., particularly preferably from 70° C. to 170° C. When the heating temperature is set in the above range, a pressure-sensitive adhesive having good adhesive properties can be obtained.

Any appropriate drying time may be used. The drying time is preferably from 5 seconds to 20 minutes, more preferably from 5 seconds to 10 minutes, particularly preferably from 10 seconds to 5 minutes.

Before the pressure-sensitive adhesive layer is formed on the surface of the optical film, an anchor layer may be formed on the surface, or any easy adhesion treatment such as a corona treatment or a plasma treatment may be performed on the surface. The surface of the pressure-sensitive adhesive layer may also be subjected to an easy adhesion treatment.

Various methods may be used to form the pressure-sensitive adhesive layer. Specific examples of such methods include roll coating, kiss roll coating, gravure coating, reverse coating, roll brush coating, spray coating, dip roll coating, bar coating, knife coating, air knife coating, curtain coating, lip coating, extrusion coating with a die coater, and the like.

The thickness of the pressure-sensitive adhesive layer is not particularly limited but is, for example, about 1 to 100 μm, preferably 2 to 50 μm, more preferably 2 to 40 μm, even more preferably 5 to 35 μm.

When the pressure-sensitive adhesive layer is exposed, the pressure-sensitive adhesive layer may be protected with a sheet having undergone release treatment (a separator) before practical use.

Examples of the material for forming the separator include a plastic film such as a polyethylene, polypropylene, polyethylene terephthalate, and polyester film; a porous material such as paper, cloth and nonwoven fabric; and an appropriate thin sheet such as a net, a foamed sheet, a metal foil, and a laminate thereof. In particular, a plastic film is preferably used, because of its good surface smoothness.

The plastic film may be any film capable of protecting the pressure-sensitive adhesive layer, and examples thereof include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, an ethylene-vinyl acetate copolymer film, and the like.

The thickness of the separator is generally from about 5 to about 200 μm, preferably from about 5 to about 100 μm. If necessary, the separator may be treated with a release agent such as a silicone, fluorine, long-chain alkyl, or fatty acid amide release agent, or may be subjected to release and antifouling treatment with silica powder or to antistatic treatment of coating type, kneading and mixing type, vapor-deposition type, or the like. In particular, if the surface of the separator is appropriately subjected to release treatment such as silicone treatment, long-chain alkyl treatment, and fluorine treatment, the peelability from the pressure-sensitive adhesive layer can be further increased.

The release-treated sheet used in the preparation of the pressure-sensitive adhesive layer attached optical film can be used as a separator for a pressure-sensitive adhesive layer attached optical film, so that the process can be simplified.

### <Image Display Device>

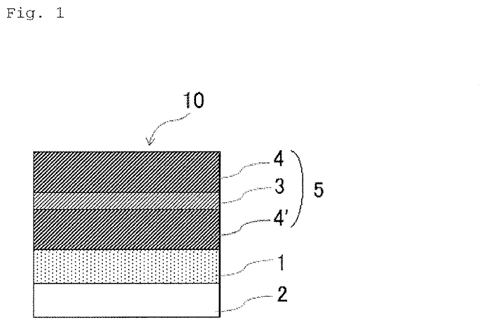

In the image display device of the present invention, it is preferable to use at least one pressure-sensitive adhesive layer attached optical film. As the optical film, a material used for forming an image display device such as a liquid crystal display device or the like is used, and its type is not particularly limited. For example, a polarizing film can be mentioned as the optical film. The polarizing film is a film including a polarizer, and a transparent protective film on one side or both sides of the polarizer can be used (see, for example, FIG. 1).

The polarizer is not particularly limited but various kinds of polarizer may be used. Examples of the polarizer, include a film obtained by uniaxial stretching after a dichromatic substance, such as iodine and dichromatic dye, is adsorbed to a hydrophilic high molecular weight polymer film, such as polyvinyl alcohol-based film, partially formalized polyvinyl alcohol-based film, and ethylene-vinyl acetate copolymer-based partially saponified film, a film polyene-based alignment film, such as dehydrated polyvinyl alcohol and dehydrochlorinated polyvinyl chloride, and the like. Among them, a polarizer composed of a polyvinyl alcohol-based film and a dichroic substance such as iodine is suitable. Thickness of these polarizers is not particularly limited but is generally about 80 μm or less.

A polarizer that is uniaxially stretched after a polyvinyl alcohol-based film dyed with iodine is obtained by stretching a polyvinyl alcohol-based film by 3 to 7 times the original length, after dipped and dyed in an aqueous solution of iodine. If necessary, the polyvinyl alcohol-based film can be immersed in an aqueous solution of potassium iodide or the like which may contain boric acid, zinc sulfate, zinc chloride or the like. Further, if necessary, the polyvinyl alcohol-based film before dyeing may be immersed in water and washed with water. By rinsing polyvinyl alcohol-based film with water, it is possible to clean contamination on the surface of the polyvinyl alcohol-based film and anti-blocking agent, and in addition, the effect of preventing unevenness such as unevenness of dyeing can be exhibited by allowing the polyvinyl alcohol-based film to be swollen. The stretching may be applied after dyeing with iodine or may be applied concurrently, or conversely dyeing with iodine may be applied after stretching. Stretching is applicable in an aqueous solution of boric acid and potassium iodide, or in water bath.

The thickness of the polarizer is preferably 30 μm or less. From the viewpoint of thinning, the thickness is more preferably 25 μm or less, even more preferably 20 μm or less, particularly preferably 15 μm or less. Such a thin type polarizer is excellent in durability even under heating/humidification conditions because of less thickness unevenness, excellent visibility, and less dimensional change, making foaming and peeling less likely to occur, and furthermore, it is preferable that the thickness of the polarizing film can also be reduced.

Typical examples of such a thin polarizer include the thin polarizers disclosed in JP-A-51-069644, JP-A-2000-338329, WO 2010/100917, specification of PCT/JP2010/001460, specification of Japanese Patent Application No. 2010-269002, or specification of Japanese Patent Application No. 2010-263692. These thin polarizers can be obtained by a process including the steps of stretching a laminate of a polyvinyl alcohol-based resin (hereinafter also referred to as PVA-based resin) layer and a stretchable resin substrate and dyeing the laminate. Using this process, the PVA-based resin layer, even when thin, can be stretched without problems such as breakage, which would otherwise be caused by stretching of the layer supported on a stretchable resin substrate.

The thin polarizer should be produced by a process capable of achieving high-ratio stretching to improve polarizing performance, among processes including the steps of stretching and dyeing a laminate. From this point of view, the thin polarizer is preferably obtained by a process including the step of stretching in an aqueous boric acid solution as described in WO 2010/100917 A, PCT/JP2010/001460, Japanese Patent Application No. 2010-269002, or Japanese Patent Application No. 2010-263692, and more preferably obtained by a process including the step of performing auxiliary in-air stretching before stretching in an aqueous boric acid solution as described in Japanese Patent Application No. 2010-269002 or 2010-263692.

A thermoplastic resin with a high level of transparency, mechanical strength, thermal stability, moisture blocking properties, isotropy, and the like may be used as a material for forming a transparent protective film. Examples of such a thermoplastic resin include cellulose resins such as triacetylcellulose, polyester resins, polyethersulfone resins, polysulfone resins, polycarbonate resins, polyamide resins, polyimide resins, polyolefin resins, (meth)acrylic resins, cyclic polyolefin resins (norbornene-based resins), polyarylate resins, polystyrene resins, polyvinyl alcohol resins, and a mixture thereof. The transparent protective film may be bonded with an adhesive layer to one side of the polarizer. On the other side of the polarizer, a thermosetting or ultraviolet-curable resin such as a (meth)acrylic, urethane, acrylic urethane, epoxy, and silicone resin may be used to form the transparent protective film. The transparent protective film may contain any one or more suitable additives. Such additives include, for example, ultraviolet absorbers, antioxidants, lubricants, plasticizers, release agents, anti-coloring agents, flame retardants, nucleating agents, antistatic agents, pigments, and colorants. The content of the thermoplastic resin in the transparent protective film is preferably from 50 to 100% by weight, more preferably from 50 to 99% by weight, even more preferably from 60 to 98% by weight, particularly preferably from 70 to 97% by weight. If the content of the thermoplastic resin in the transparent protective film is 50% by weight or less, high transparency and other properties inherent in the thermoplastic resin may be insufficiently exhibited.

The adhesive used to bond the polarizer to the transparent protective film may be any of various optically-transparent adhesives, such as aqueous adhesives, solvent type adhesives, hot melt type adhesives, radical-curable type adhesives, and cationically curable type adhesives, among which aqueous adhesives or radical-curable type adhesives are preferred.

Examples of the optical film include a reflector, a transflector, a retardation film (including a wavelength plate such as a half or quarter wavelength plate), a viewing angle compensation film, a brightness enhancement film, and any other optical layer that can be used to form liquid crystal display devices or other devices. They may be used alone as the optical film, or one or more layers of any of them may be used together with the polarizing film to form a laminate for practical use.

The optical film including a laminate of the polarizing film and the optical layer may be formed by a method of laminating them one by one in the process of manufacturing a liquid crystal display device or the like. However, an optical film formed in advance by lamination is advantageous in that it can facilitate the process of manufacturing a liquid crystal display device or the like because it has stable quality and good assembling workability. In the lamination, any appropriate bonding means such as a pressure-sensitive adhesive layer may be used. When the polarizing film and any other optical layer are bonded together, their optical axes may be each aligned at an appropriate angle, depending on the desired retardation properties or other desired properties.

The pressure-sensitive adhesive layer attached optical film according to the present invention is preferably used to form liquid crystal display devices or other various image display devices. Liquid crystal display devices may be formed according to conventional techniques. Namely, a liquid crystal display device may be typically formed by appropriately assembling a display panel such as a liquid crystal cell, a pressure-sensitive adhesive layer attached optical film, and a component such as a lighting system as needed, and incorporating a driving circuit according to any conventional techniques, as long as the pressure-sensitive adhesive layer attached optical film according to the present invention is used. The liquid crystal cell to be used may also be of any type such as TN type, STN type, π type, VA type, or IPS type.

An appropriate liquid crystal display device such as a liquid crystal display device in which a pressure-sensitive adhesive layer attached optical film is disposed on one side or both sides of a display panel such as a liquid crystal cell, or a liquid crystal display device using a backlight or a reflector in a lighting system can be formed. In that case, the pressure-sensitive adhesive layer attached optical film according to the present invention can be disposed on one side or both sides of a display panel such as a liquid crystal cell. When optical films are provided on both sides, they may be the same as or different from each other. Furthermore, in assembling a liquid crystal display, suitable parts, such as diffusion layer, anti-glare layer, antireflection film, protective plate, prism array, lens array sheet, optical diffusion sheet, and backlight, may be disposed in suitable position in one layer or two or more layers.

### EXAMPLES

The present invention is specifically described by Examples below, which are not intended to limit the scope of the present invention. In each Example, parts and percentages are all on a weight basis. Unless otherwise stated below, the conditions of room temperature standing are 23° C. and 65% RH in all the cases.

### <Measurement of Weight Average Molecular Weight (Mw) of (Meth)Acrylic Polymer>

The weight average molecular weight (Mw) of the (meth)acrylic polymer was measured by GPC (gel permeation chromatography). The polydispersity (Mw/Mn) of the (meth)acrylic polymer was also determined using the same method.
Analyzer: HLC-8120 GPC, manufactured by TOSOH CORPORATION
Columns: G7000 H_{XL}+GM H_{XL}+GM H_{XL}, manufactured by TOSOH CORPORATION
Column size: each 7.8 mmφ×30 cm, 90 cm in total
Column temperature: 40° C.
Flow rate: 0.8 ml/minute
Injection volume: 100 μl
Eluent: 10 mM phosphoric acid/tetrahydrofuran
Detector: differential refractometer (RI)
Standard sample: polystyrene

### <Preparation of Polarizing Film (Polarizing Plate)>

An 80-μm-thick polyvinyl alcohol film was stretched to 3 times between rolls different in velocity ratio while the film was dyed in a 0.3% iodine solution at 30° C. for 1 minute. The film was then stretched to a total stretch ratio of 6 times while the film was immersed in an aqueous solution containing 4% of boric acid and 10% of potassium iodide at 60° C. for 0.5 minutes. Subsequently, the film was washed by immersion in an aqueous solution containing 1.5% of potassium iodide at 30° C. for 10 seconds and then dried at 50° C. for 4 minutes to give a 28-μm-thick polarizer. A polarizing film (a polarizing plate) was formed by bonding an 80-μm-thick saponified triacetylcellulose (TAC) films to both sides of the polarizer with a polyvinyl alcohol-based adhesive.

### Example 1

### (Preparation of (Meth)Acrylic Polymer (A1))

A monomer mixture containing 83 parts of butyl acrylate, 16 parts of phenoxyethyl acrylate, and 1 part of 4-hydroxybutyl acrylate was charged into a four-necked flask equipped with a stirring blade, a thermometer, a nitrogen gas inlet tube and a condenser. Further, 0.1 parts of 2,2′-azobisisobutyronitrile as a polymerization initiator was added to 100 parts of the monomer mixture (solid content) together with 85 parts of ethyl acetate and 15 parts of toluene. The mixture was gently stirred while introducing nitrogen gas and purging the flask with nitrogen, and then polymerization reaction was carried out for 30 minutes while keeping the liquid temperature in the flask at around 55° C. to prepare a solution of an acrylic polymer (A1) having a weight average molecular weight (Mw) of 1.6 million and a ratio Mw/Mn of 1.84.

### (Preparation of Pressure-Sensitive Adhesive Composition)

A solution of an acrylic pressure-sensitive adhesive composition was prepared by blending 0.1 parts of an isocyanate-based crosslinking agent (TAKENATE D-160N, trimethylolpropane hexamethylene diisocyanate, manufactured by Mitsui Chemicals, Inc.), 0.3 parts of a peroxide-based crosslinking agent (NYPER BMT, benzoyl peroxide, manufactured by NOF Corporation), and 0.2 parts of a silane coupling agent (X-41-1810, a thiol group-containing silicate oligomer, manufactured by Shin-Etsu Chemical Co., Ltd.), based on 100 parts of the solid content of the (meth)acrylic polymer (A1) solution obtained above.

### (Preparation of Pressure-Sensitive Adhesive Layer Attached Polarizing Film)

Next, the solution of the acrylic pressure-sensitive adhesive composition was coated on one side of a polyethylene terephthalate film (separator film: MRF 38, manufactured by Mitsubishi Polyester Film Corporation) treated with a silicone-based release agent in such a manner that the thickness of the pressure-sensitive adhesive layer after drying became 20 μm, and then dried at 155° C. for 1 minute to form a pressure-sensitive adhesive layer on the surface of the separator film. Subsequently, the pressure-sensitive adhesive layer formed on the separator film was transferred to the produced polarizing film to prepare a pressure-sensitive adhesive layer attached polarizing film.

### (Preparation of (Meth)Acrylic Polymers (A2) and (A9))

Solutions of (meth)acrylic polymers (A2) and (A9) were prepared in the same manner as the (meth)acrylic polymer (A1) except that each monomer mixture shown in Table 1 was used.

### (Preparation of (Meth)Acrylic Polymer (A3): Living Radical Polymerization)

In a glove box substituted with argon, 0.035 parts of ethyl 2-methyl-2-n-butyltellanyl-propionate, 0.0025 parts of 2,2′-azobisisobutyronitrile, and 1 part of ethyl acetate were placed into a reaction vessel. Then, the reaction vessel was sealed and taken out from the glove box.

Subsequently, 83 parts of butyl acrylate, 16 parts of phenoxyethyl acrylate, 1 part of 4-hydroxybutyl acrylate, and 50 parts of ethyl acetate as a polymerization solvent were charged into the reaction vessel while argon gas was flowing into the reaction vessel, and polymerization reaction was carried out for 20 hours while keeping the liquid temperature in the reaction vessel at about 60° C. to prepare a (meth)acrylic polymer (A3) solution.

### (Preparation of (Meth)Acrylic Polymer (A4))

A (meth)acrylic polymer (A4) solution was prepared in the same manner as in the (preparation of (meth)acrylic polymer (A3)) except that the monomer mixture shown in Table 1 was used.

### (Preparation of (Meth)Acrylic Polymer (A5))

A (meth)acrylic polymer (A5) solution was prepared in the same manner as the (meth)acrylic polymer (A1) except that each monomer mixture shown in Table 1 was charged and then the polymerization solvent was changed to 70 parts of ethyl acetate and 30 parts of toluene.

### (Preparation of (Meth)Acrylic Polymer (A6))

A (meth)acrylic polymer (A6) solution was prepared in the same manner as in the (preparation of (meth)acrylic polymer (A1)) except that the monomer mixture shown in Table 1 was charged and then the polymerization reaction time was changed to 2 hours.

### (Preparation of (Meth)Acrylic Polymers (A7) and (A8))

Solutions of (meth)acrylic polymers (A7) and (A8) were prepared in the same manner as the (meth)acrylic polymer (A1) except that each monomer mixture shown in Table 1 was charged and the polymerization reaction time was changed to 6 hours.

### Examples 2 to 6 and Comparative Examples 1 to 4

In Examples 2 to 6 and Comparative Examples 1 to 4, solutions of (meth)acrylic polymers (A2) to (A9) having polymer physical properties (weight average molecular weight (Mw), polydispersity (Mw/Mn), etc.) shown in Table 1 were prepared in the same manner as in Example 1 except that the preparation methods of the (meth)acrylic polymers (A2) to (A9), the kind and the blending proportion of the monomers were changed as shown in Table 1 while controlling the production conditions.

Further, a solution of an acrylic pressure-sensitive adhesive composition was prepared in the same manner as in Example 1 except that the kind of the crosslinking agent and the amount of the crosslinking agent were changed as shown in Table 1 with respect to each solution of the obtained (meth)acrylic polymer. In addition, a pressure-sensitive adhesive layer attached polarizing film was prepared in the same manner as in Example 1 using the solution of the acrylic pressure-sensitive adhesive composition.

The following evaluations were performed on the pressure-sensitive adhesive layer attached polarizing films obtained in Examples and Comparative Examples. The evaluation results are shown in Table 2.

### <Durability Test on ITO Glass>

A pressure-sensitive adhesive layer attached polarizing film cut into a size of 37 inches was used as a sample. An amorphous ITO layer was formed on an alkali-free glass (EG-XG, manufactured by Corning Incorporated) having a thickness of 0.7 mm and used as an adherend. The sample of the pressure-sensitive adhesive layer attached polarizing film was laminated to the surface of an amorphous ITO layer using a laminator. Then, the laminate was autoclaved at 50° C. and 0.5 MPa for 15 minutes to completely adhere the sample to the adherend. The sample subjected to such treatment was treated for 500 hours under each atmosphere of 95° C. and 65° C./95% RH, and then the appearance between the polarizing film and the amorphous ITO layer was visually observed according to the following criteria, thereby to evaluate the durability against the ITO glass. The ITO layer was formed by a sputtering method. The composition of ITO had an Sn ratio of 3% by weight, and a heating step of 140° C.×60 minutes was carried out before bonding the samples, respectively. The Sn content of ITO was calculated from weight of Sn atoms/(weight of Sn atoms+weight of In atoms).

### (Evaluation Criteria)

⊙: In the sample, there is no change at all in appearance such as foaming, peeling or the like.
◯: Slight peeling or foaming occurs at the end portion of the sample, but there is no problem in practical use.
Δ: Peeling or foaming occurs at the end portion of the sample, but there is no problem in practical use except for special applications.
x: Significant peeling occurs at the end portion of the sample, causing problems in practical use.

### <Display Unevenness>

Two pressure-sensitive adhesive layer attached polarizing films were cut out in a size of 420 mm in length×320 mm in width to prepare samples. These samples were laminated on both sides of a 0.07 mm thick alkali-free glass plate with a laminator so as to be in a cross nicol state. Next, autoclave treatment was carried out at 50° C. and 5 atm for 15 minutes to obtain a secondary sample (initial stage). Subsequently, the secondary sample was treated at 90° C. for 24 hours (after heating). The secondary samples at initial stage and after heating were placed on a 10,000 candela backlight, and light leakage was visually evaluated according to the criteria below.

### (Evaluation Criteria)

⊙: No corner unevenness occurs, causing no problem in practical use.
◯: Corner unevenness occurs slightly, but it does not appear in the display area, so there is no practical problem.
Δ: Corner unevenness occurs and appears slightly in the display area, but there is no practical problem.
x: Corner unevenness occurs and appears significantly in the display area, causing problems in practical use.

### <Adhering Strength to Glass>

A pressure-sensitive adhesive layer attached polarizing film was cut into a size of 120 mm in length×25 mm in width, which was used as a sample. The sample was attached to a 0.7 mm thick alkali-free glass plate (EG-XG, manufactured by Corning Incorporated) using a laminator and then autoclaved at 50° C. and 5 atm for 15 minutes to completely adhere the sample. Thereafter, the adhering strength of the sample was measured. The adhering strength (N/25 mm, measurement length 80 mm) was measured when the sample was peeled off at a peel angle of 90° and a peel rate of 300 mm/min with a tensile tester (Autograph SHIMAZU AG-1 10 KN). The measurements were sampled at intervals of one time/0.5 seconds, and the average of the resultant values was used as a measured value of the sample.

The adhering strength to glass of the optical pressure-sensitive adhesive layer of the present invention is 11 N/25 mm or less, preferably 10 N/25 mm or less, more preferably 4 to 9 N/25 mm. When the adhering strength to glass exceeds 11 N/25 mm, the adhering strength increases and the reworkability is poor, which is not preferable. In particular, when a display panel of a curved design is used for in-vehicle display, thinning of the glass substrate of the display device is required, but since the panel is liable to be damaged or the like during the rework operation of the polarizing film, it is required to set the adhering strength to 11 N/25 mm or less. Also, from the viewpoint of durability (peeling etc.), the adhering strength is preferably 1 N/25 mm or more.

### <Reworkability>

Based on the adhering strength to glass, evaluation of reworkability of the pressure-sensitive adhesive layer attached polarizing films were performed according to the following criteria.

### (Evaluation Criteria)

⊙: The adhering strength to glass is 4 N/25 mm or more and 7 N/25 mm or less.
◯: The adhering strength to glass exceeds 7 N/25 mm and 9 N/25 mm or less.
Δ: The adhering strength to glass exceeds 9 N/25 mm and 11 N/25 mm or less.
x: The adhering strength to glass exceeds 11 N/25 mm.

TABLE 1

| | | | | | | | | Physical | | | | |
|---|---|---|---|---|---|---|---|---|---|---|---|---|
| | (Meth) | | | | | | | properties of | | Crosslinking | | Silane |
| | acrylic | Composition of polymer | | | | | | polymer | | agent | | coupling |
| | polymer | BA | PEA | BzA | AA | NVP | HBA | Mw | Mw/Mn | Isocyanate | Peroxide | agent |
| Example 1 | (A1) | 83 | 16 | | | | 1 | 1.6 million | 1.84 | 0.1 | 0.3 | 0.2 |
| Example 2 | (A2) | 78 | | 21 | | | 1 | 1.74 million | 1.94 | 0.1 | 0.3 | 0.2 |
| Example 3 | (A3) | 83 | 16 | | | | 1 | 1.4 million | 1.88 | 0.1 | 0.3 | 0.2 |
| Example 4 | (A4) | 76 | 16 | | | 5 | 3 | 1.75 million | 1.91 | 0.1 | 0.3 | 0.2 |
| Example 5 | (A5) | 83 | 16 | | | | 1 | 0.84 million | 1.51 | 0.1 | 0.4 | 0.2 |
| Example 6 | (A6) | 78 | 16 | | | 5 | 1 | 1.74 million | 2.78 | 0.1 | 0.3 | 0.2 |
| Comparative | (A7) | 99 | | | | | 1 | 1.82 million | 4.12 | 0.1 | 0.3 | 0.2 |
| Example 1 | | | | | | | | | | | | |
| Comparative | (A8) | 83 | 16 | | | | 1 | 1.78 million | 4.02 | 0.1 | 0.3 | 0.2 |
| Example 2 | | | | | | | | | | | | |
| Comparative | (A9) | 78.7 | 16 | | 5 | | 0.3 | 1.9 million | 2.20 | 0.3 | 0.1 | 0.2 |
| Example 3 | | | | | | | | | | | | |

Abbreviations and the like in Table 1 are described below.

BA: Butyl acrylate (Tg: −55° C.)

PEA: Phenoxyethyl acrylate (Tg: −22° C.)

BzA: Benzyl acrylate (Tg: 6° C.)

AA: Acrylic acid (Tg: 106° C.)

NVP: N-Vinyl-pyrrolidone (Tg: 65° C.)

HBA: 4-Hydroxybutyl acrylate (Tg: −40° C.)

Isocyanate: TAKENATE D 160N (a hexamethylene diisocyanate adduct of trimethylolpropane), manufactured by Mitsui Chemicals, Inc.

Peroxide: NYPER BMT (benzoyl peroxide), manufactured by NOF Corporation

Silane coupling agent: X-41-1810 (a thiol group-containing silicate oligomer), manufactured by Shin-Etsu Chemical Co., Ltd.

TABLE 2

| | Durability | | | Adhering | |
|---|---|---|---|---|---|
| | | 65° C. | | strength to | Rework- |
| | 95° C. | 95% RH | Unevenness | glass | ability |
| Example 1 | ◯ | ◯ | ◯ | 5.8 | ⊙ |
| Example 2 | ◯ | ◯ | ◯ | 7.9 | ◯ |
| Example 3 | ⊙ | ◯ | ◯ | 5.8 | ⊙ |
| Example 4 | ⊙ | ⊙ | ◯ | 8.8 | ◯ |
| Example 5 | Δ | Δ | ◯ | 6.3 | ⊙ |
| Example 6 | ◯ | ◯ | ◯ | 8.6 | ◯ |
| Comparative | X | ◯ | X | 4.5 | ⊙ |
| Example 1 | | | | | |
| Comparative | X | ◯ | ◯ | 6 | ⊙ |
| Example 2 | | | | | |
| Comparative | ◯ | ◯ | ◯ | 12 | X |
| Example 3 | | | | | |

From the results in Table 2, it was confirmed in Examples that by using an optical pressure-sensitive adhesive layer having predetermined adhering strength obtained with use of a (meth)acrylic polymer having a specific polydispersity obtained by using a specific ratio of an aromatic ring-containing monomer, display unevenness can be suppressed and since the optical pressure-sensitive adhesive layer is excellent in adhesion property, reworkability, durability (heat resistance and moisture resistance), such adhesive layer can be practically used even in applications requiring these properties. In particular, when using a display panel with a curved design for in-vehicle display, reworkability and durability for the optical pressure-sensitive adhesive layer are required, but such adhesive layer is useful because it can also satisfy these required characteristics.

On the other hand, in Comparative Examples, since the aromatic ring-containing monomer was not used in a specific proportion or no predetermined adhering strength was obtained, it was impossible to obtain optical pressure-sensitive adhesive layers satisfying all such properties.

### DESCRIPTION OF REFERENCE SIGNS

1 Pressure-sensitive adhesive layer
2 Separator
3 Polarizer
4, 4′ Protective film
5 Polarizing film (polarizing plate)
10 Pressure-sensitive adhesive layer attached polarizing film

1. An optical pressure-sensitive adhesive layer formed from a pressure-sensitive adhesive composition containing a (meth)acrylic polymer that contains 3 to 25% by weight of an aromatic ring-containing monomer as a monomer unit and has a polydispersity (weight average molecular weight (Mw)/number average molecular weight (Mn)) of 3.0 or less,
wherein the optical pressure-sensitive adhesive layer has an adhering strength of 11 N/25 mm or less to glass, and
the (meth)acrylic polymer contains 0.1 to 15% by weight of an N-vinyl group-containing lactam-based monomer as a monomer unit.

2. The optical pressure-sensitive adhesive layer according to claim 1, wherein a glass transition temperature (Tg) of a polymer consisting of the aromatic ring-containing monomer is 0° C. or less.

3. The optical pressure-sensitive adhesive layer according to claim 1, wherein the aromatic ring-containing monomer is phenoxyethyl (meth)acrylate.

4. The optical pressure-sensitive adhesive layer according to claim 1, wherein a weight average molecular weight (Mw) of the (meth)acrylic polymer is from 900,000 to 3,000,000.

5. The optical pressure-sensitive adhesive layer according to claim 1, wherein the (meth)acrylic polymer contains 1.5% by weight or less of a carboxyl group-containing monomer as a monomer unit.

6. The optical pressure-sensitive adhesive layer according to claim 1, wherein a peroxide-based crosslinking agent is contained in an amount of 0.01 to 3 parts by weight based on 100 parts by weight of the (meth)acrylic polymer.

7. The optical pressure-sensitive adhesive layer according to claim 1, wherein the pressure-sensitive adhesive composition contains an organic tellurium compound.

8. A method for manufacturing the optical pressure-sensitive adhesive layer according to claim 1, wherein the (meth)acrylic polymer is produced by living radical polymerization.

9. A pressure-sensitive adhesive layer attached optical film, comprising the optical pressure-sensitive adhesive layer according to claim 1 on at least one side of the optical film.

10. An image display device comprising at least one pressure-sensitive adhesive layer attached optical film according to claim 9.

11. An optical pressure-sensitive adhesive layer formed from a pressure-sensitive adhesive composition containing
a (meth)acrylic polymer that contains 3 to 25% by weight of an aromatic ring-containing monomer as a monomer unit and has a polydispersity (weight average molecular weight (Mw)/number average molecular weight (Mn)) of 3.0 or less,
a peroxide crosslinking agent and
an isocyanate crosslinking agent,
wherein the optical pressure-sensitive adhesive layer has an adhering strength of 11 N/25 mm or less to glass.

12. The optical pressure-sensitive adhesive layer according to claim 11, wherein a glass transition temperature (Tg) of a polymer consisting of the aromatic ring-containing monomer is 0° C. or less.

13. The optical pressure-sensitive adhesive layer according to claim 11, wherein the aromatic ring-containing monomer is phenoxyethyl (meth)acrylate.

14. The optical pressure-sensitive adhesive layer according to claim 11, wherein a weight average molecular weight (Mw) of the (meth)acrylic polymer is from 900,000 to 3,000,000.

15. The optical pressure-sensitive adhesive layer according to claim 11, wherein the (meth)acrylic polymer contains 1.5% by weight or less of a carboxyl group-containing monomer as a monomer unit.

16. The optical pressure-sensitive adhesive layer according claim 11, wherein the (meth)acrylic polymer contains 0.1 to 15% by weight of an N-vinyl group-containing lactam-based monomer as a monomer unit.

17. The optical pressure-sensitive adhesive layer according to claim 11, wherein the peroxide-based crosslinking agent is contained in an amount of 0.01 to 3 parts by weight based on 100 parts by weight of the (meth)acrylic polymer.

18. The optical pressure-sensitive adhesive layer according to claim 11, wherein the pressure-sensitive adhesive composition contains an organic tellurium compound.

19. A method for manufacturing the optical pressure-sensitive adhesive layer according to claim 11, wherein the (meth)acrylic polymer is produced by living radical polymerization.

20. A pressure-sensitive adhesive layer attached optical film, comprising the optical pressure-sensitive adhesive layer according to claim 11 on at least one side of the optical film.

21. An image display device comprising at least one pressure-sensitive adhesive layer attached optical film according to claim 11.
